(19) United States
(12) Patent Application Publication
(10) Pub. No.: US 2011/0183059 A1
(43) Pub. Date: Jul. 28, 2011

(54) READY TO BAKE REFRIDGERATED BATTER

(75) Inventor: Robert P. STANTON, St. Louis, MO (US)

(73) Assignee: Oven Luv'n LLC, Shirley, NY (US)

(21) Appl. No.: 13/012,505

(22) Filed: Jan. 24, 2011

Related U.S. Application Data
(63) Continuation-in-part of application No. 11/505,118, filed on Aug. 16, 2006, now abandoned.
(60) Provisional application No. 60/708,930, filed on Aug. 17, 2005.

(51) Int. Cl. A21D 10/04

(52) U.S. Cl. 426/552; 426/549

(57) ABSTRACT

A stiff batter is provided having a range of about 0.5% to about 2% gelatin, a range of about 10% to about 60% farinaceous ingredient, and a range of about 5% to about 30% fat. The fat has about 35% to about 70% solid fat content at approximately 10° C. Used percentages of solid fat content and gelatin in their corresponding ranges are inversely proportional. The stiff batter has a pre-baked yield stress greater than 3000 Pascals (Pa) at approximately 4.5° C., a baked specific volume of at least 2.0 cubic centimeters (cc/gm), and maintains the baked specific volume at approximately 4.5° C. for more than 75 days. All percentages, with the exception of the solid fat content, are based on a weight of the stiff batter. The stiff batter does not require gluten development to achieve the baked specific volume of at least 2.0 cc/gm.

### PRIORITY

This application is a Continuation-in-Part application of U.S. patent application Ser. No. 11/505,118 filed on Aug. 16, 2006, which claims the benefit of U.S. provisional application Ser. No. 60/708,930 filed Aug. 17, 2005.

### BACKGROUND OF THE INVENTION

1. Field of the Application

The present application is related generally to ready-to-bake farinaceous batter compositions, and more particularly, to ready-to-bake farinaceous batter compositions that are stiff and sliceable at refrigeration temperatures, and baked goods made from such batters.

2. Description of the Related Art

Baked goods such as cakes, muffins, donuts, cupcakes, pancakes, muffin tops, brownies, drop biscuits, cinnamon buns, waffles, and scones are made from batters. In this context, a batter can be defined as containing wheat flour, sugar, egg, water, fat, leavening, and other minor ingredients. Batter is typically thin enough to be either poured, scooped, or spooned. Mixing time and speed are kept to a minimum to prevent significant gluten development. Batters bake into moist and tender products with a light and porous cell structure.

Making a batter from scratch is inconvenient and time-consuming. Therefore, the following more convenient forms of batters have been developed.
Dry bakery mixes: The end user adds water and/or other liquids (milk, eggs, vegetable oil) to the dry blend and mixes the ingredients with either a spoon or mixer. Subsequently, the batter is poured into a baking pan. This method is cumbersome and messy due to the utensils or equipment required, the pouring of the batter, and preparation time required.
Ready to bake frozen batter: The end user must thaw the batter, then scoop and bake. The frozen batter is commonly supplied in 15-30 pound (lb) Pails, which require 36 to 72 hours to completely thaw before the batter can be scooped. Once the batter is thawed, it cannot be refrozen and will have a refrigerated shelf life of approximately 7 days.
Ready to bake spoonable frozen batter (See U.S. Pat. No. 6,391,366 to Boldon): The end user spoons the frozen batter and places it into bakeware straight from the freezer. No thawing is required to handle the product as the batter is soft enough at frozen temperatures to be scooped.
Ready to bake pourable batter stored at ambient temperatures (See U.S. Pat. No. 6,224,924 to Narayanaswamy): A low water activity batter is held under modified atmosphere packaging and has a shelf life of up to 9 months at ambient temperatures. The batter is poured into a baking pan and baked in an oven.
Ready to bake refrigerated spoonable batter (See U.S. Pat. No. 6,217,929 to Hahn): The batter is stored under refrigerated temperatures and is spooned into bakeware. No modified atmosphere packaging is required since the water activity is low enough to sustain a shelf life of 75 days. However, due to its lower yield stress, the batter does not retain its shape under refrigerated conditions and must be placed in a suitable container such as a pail.

### SUMMARY OF THE INVENTION

The present invention has been made to address at least the above problems and/or disadvantages and to provide at least the advantages described below. Accordingly, an aspect of the present invention provides a stiff batter having a pre-baked yield stress greater than 3000 Pascals (Pa) at approximately 4.5° C., a baked specific volume of at least 2.0 cubic centimeters/gram (cc/gm), and maintains the baked specific volume at approximately 4.5° C. for more than 75 days.

According to one aspect of the present invention, a stiff batter is provided having a range of about 0.5% to about 2% gelatin, a range of about 10% to about 60% farinaceous ingredient, and a range of about 5% to about 30% fat. The fat has about 35% to about 70% solid fat content at approximately 10° C. Used percentages of solid fat content and gelatin in their corresponding ranges are inversely proportional. The stiff batter has a pre-baked yield stress greater than 3000 Pa at approximately 4.5° C., a baked specific volume of at least 2.0 cc/gm, and maintains the baked specific volume at approximately 4.5° C. for more than 75 days. All percentages, with the exception of the solid fat content, are based on a weight of the stiff batter. The stiff batter does not require gluten development to achieve the baked specific volume of at least 2.0 cc/gm.

According to another aspect of the present invention, a stiff batter is provided having a range from about 10% to about 60% farinaceous ingredient, a range from about 0.5% to about 2% gelatin, and a range from about 5% to about 30% fat. The fat has about 35% to about 70% solid fat content at approximately 10° C. Used percentages of solid fat content and gelatin in their corresponding ranges are inversely proportional. The stiff batter also has a range from about 10% to about 50% humectant, a range from about 10% to about 40% moisture, a range from 0 to about 1% anti-microbial agent, a range from 0 to about 5% emulsifier, a range from 0 to 3% leavening system, and a range from 0 to about 15% texturizing agent. The stiff batter has a pre-baked yield stress greater than 3000 Pa at approximately 4.5° C., a baked specific volume of at least 2.0 cc/gm, and maintains the baked specific volume at approximately 4.5° C. for more than 75 days. All percentages, with the exception of the solid fat content, are based on a weight of the stiff batter. The stiff batter does not require gluten development to achieve the baked specific volume of at least 2.0 cc/gm.

### BRIEF DESCRIPTION OF THE DRAWINGS

The above and other aspects, features and advantages of the present invention will be more apparent from the following detailed description when taken in conjunction with the accompanying drawings, in which:

FIG. 1 shows gluten development vs. yield stress for various types of doughs and batters including embodiments of the present invention;

FIG. 2 shows a comparison of baked specific volume vs. yield stress for batters and doughs with a refrigerated shelf life of more than 7 days including embodiments of the present invention;

FIG. 3 is a side elevational view of a “chub”, according to an embodiment of the present invention; and

FIG. 4 shows a comparison of baked specific volume vs. time for products of Hahn and embodiments of the present invention.

### DETAILED DESCRIPTION OF EMBODIMENTS OF THE PRESENT INVENTION

Embodiments of the present invention are described in detail with reference to the accompanying drawings. Detailed descriptions of constructions or processes known in the art may be omitted to avoid obscuring the subject matter of the present invention.

All of the forgoing listed batter forms are the same or slightly stiffer than typical batters, but none are as stiff as dough. Stiffness can be quantified in terms of yield stress, which is measured in Pa. Yield stress can be defined as the minimum amount of stress that must be applied to a structured fluid in order for it to begin to flow. The stiffer the batter, the higher the yield stress. For example, pancake batter has a yield stress value of about 100 Pa, and cookie dough has a yield stress value of over 3000 Pa. All of the foregoing listed batter forms have a yield stress of less than 1500 Pa. Embodiments of the present invention have a yield stress that is preferably greater than 3000 Pa.

In terms of yield stress, the embodiments of the present invention appear to be doughs. However, doughs that bake into products with a high specific volume require a level of gluten development that is significantly higher than that required by batters. Therefore, the embodiments of the present invention cannot be considered a true dough, and are referred to as a stiff batter or an undeveloped dough.

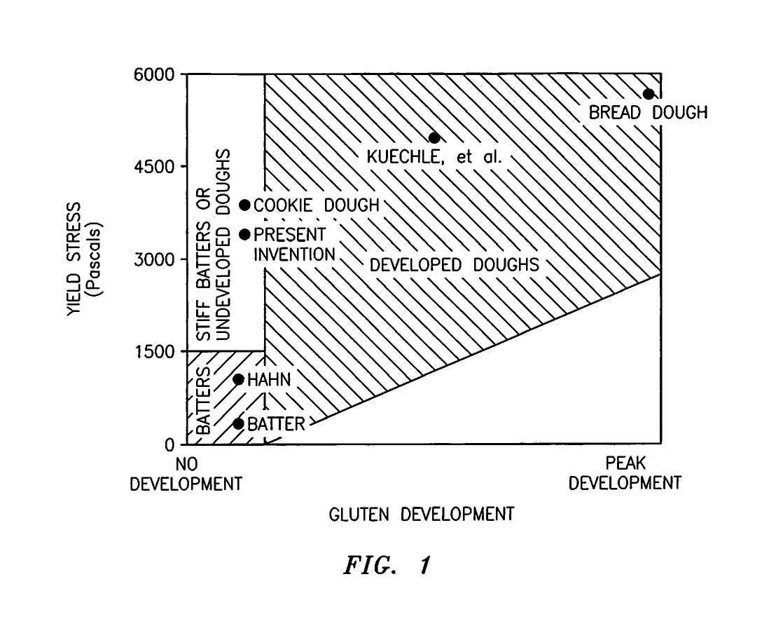

FIG. 1 illustrates the difference between a batter and dough in terms of gluten development. Bread dough is shown has having both a high yield stress (over 4500 Pa) and substantially peak gluten development.

U.S. Pat. No. 6,436,458 to Kuechle and U.S. Pat. No. 6,803,067 to Braginsky, which may be considered developed doughs, describe methods of preparing a stiff muffin, or coffee cake dough. The refrigerated shelf life of these products is only 7 days and the texture of the products is more bread-like than the embodiments of the present invention due to the high levels of flour (30-50%), low levels of sugar (<12%), and higher levels of gluten development. Specifically, FIG. 1 illustrates that Kuechle has a high yield stress (approximately 4500 Pa) as well as significant gluten development.

In FIG. 1, standard batter is shown as having a very low yield stress (under 1500 Pa) and insignificant gluten development. Hahn's batter is shown as having a yield stress near 1500 Pa and insignificant gluten development.

The embodiments of the present invention are illustrated as stiff batters or undeveloped doughs having a high yield stress (over 3000 Pa) and insignificant gluten development. Although cookie dough is shown to have similar properties, it differs from the embodiments of the present invention in terms of its baked specific volume. Specifically, cookie dough achieves its stiffness by having a lower water content and therefore a higher solids content.

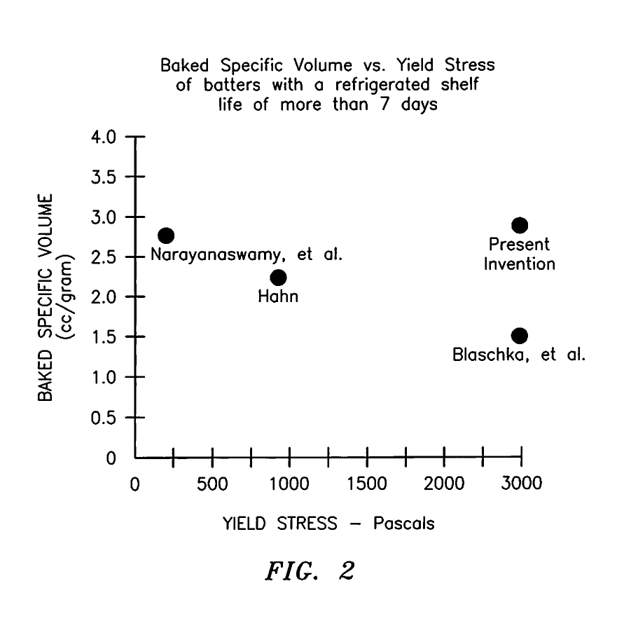

FIG. 2 illustrates the difference between the embodiments of the present invention and other batters and doughs having a shelf life of greater than 7 days at refrigerated temperatures (approximately 4.5° C.). U.S. Pat. No. 6,413,563 to Blaschke describes a ready to bake refrigerated cake dough. Although the formulation of the cake dough of Blaschke is stiff (near 3000 Pa), the resulting baked specific volume is very low (under 1.5 cc/g) and the resulting texture is dense. Narayanaswamy is illustrated as having a very low yield stress (under 250 Pa) and a high baked specific volume (over 2.5 cc/g). Hahn is illustrated as having a yield stress under 1500 Pa, and a baked specific volume approximately 2.0 cc/g.

As shown in FIG. 2, the yield stress of a batter or dough is typically inversely proportional to the baked specific volume; i.e., a stiff batter would bake into a dense product with a thick crust. Accordingly, it is apparent that the embodiments of the present invention are alone in having a high yield stress (near 3000 Pa) and a baked specific volume (over 2.0 cc/g, and preferably over 2.5 cc/g).

More specifically, the embodiments of the present invention have a high yield stress and achieve a high baked specific volume with insignificant gluten development. The embodiments of the present invention differ from traditional batters, including Hahn, by having a higher yield stress. The embodiments of the present invention differ from traditional doughs by having insignificant gluten development. The embodiments of the present invention differ from other stiff batters or undeveloped doughs, including cookie dough, by having a higher baked specific volume.

The four main advantages of the stiff batter of the embodiments of the present invention are:

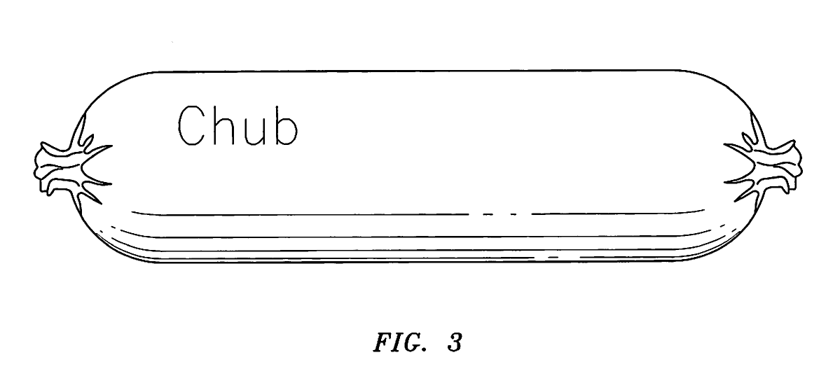

1) A refrigerated batter is more convenient to the consumer because it retains its shape and thus can be stored in forms that permit easy portioning. One example of a convenient form is individual portions like round or hex pucks. Another example is a log format where the portions can be sliced from the log. The log format is typically packaged in “chubs” (see FIG. 3), which are commonly used for cookie dough. Whatever the form, the end user would place the portion or portions onto a suitable baking pan and bake the product for a pre-determined amount of time.

2) Refrigerated batters can produce higher quality products than frozen batters.

3) A refrigerated stiff batter is not as messy as batters that are poured or scooped since spillage is eliminated.

4) Whatever the format, the package can be partially used and then returned to the refrigerator (or freezer) after opening for use at a later date.

In one embodiment, the batter of this application contains flour, fat, humectants, moisture, edible food grade hydrocolloids, leavening agents, and other minor ingredients. The batter may also contain starch and, if necessary, anti-microbial agents. For example, anti-microbial agents may not be required in a brownie but may be required in a muffin. Optionally a leavening system can be omitted in making certain products. The batter is shelf stable at refrigerated temperatures for at least about 75 days, and preferably greater than about 112 days, and has a yield stress value of greater than about 3000 Pa at 4.5° C. The batter of the present invention bakes into a product with a specific volume typical of baked goods made from scratch batters, i.e. >2.0 cc/g. Whenever percentages of ingredients are given hereinafter, they refer to weight percentage (wt. %) based on the total weight of the batter. Shelf stable or shelf life, refers to the time from when the batter is formulated and packaged to the time it is baked by the consumer.

The overall stiffness of the batter is achieved by the combination of ingredients listed hereafter. The use of hydrocolloids at low concentrations is one of the contributing ingredients for producing the stiff batter of this application. Food grade edible hydrocolloids that can be used include the following or combinations of the following: xanthan gum, guar gum, gelatin, instant gelatin, locust bean gum, tara gum, konjac, gum arabic, tragacanth, gum karaya, agar, carrageenan, sodium alginate, propylene glycol alginate, pectin, gellan gum, pullulan, cellulose gum, methylcellulose, hydroxypropylcellulose, methylhydroxypropylcellulose, microcrystalline cellulose, and the like. The level of hydrocolloid addition preferably can range from about 0.1% to about 5%.

The preferred hydrocolloid for stiffening the batter is gelatin. The advantage of using gelatin is that it has a high water binding capacity and therefore, a low percentage is required to achieve a stiff dough. In addition, since the gelatin has a low melt temperature, the gel breaks down in the oven to create a soft enough batter so that it can rise. In addition, the low melt temperature causes the gel to melt in the mouth and therefore the baked product does not appear to have a gummy texture. The preferred embodiment of the present invention includes gelatin in a range from about 0.5% to about 2%.

Batter of the embodiments of the present invention depends on farinaceous ingredients based on flour and/or starch for structure. The flour and/or starch level preferably ranges from about 10% to about 60%. Flours that can be used include the following or combinations of the following: hard wheat flour, soft wheat flour, chlorinated wheat flour, corn flour, soy, flour, rice flour, high amylose flour, low amylose flour, and the like.

Wheat flour is the preferred flour. Chlorinated wheat flour improves the solubility of the starch thereby improving the overall volume of the baked product. It is suitable to use a wheat flour that has gone through dry sterilization, infrared heating, microwave heating, irradiation, or any other process that would decrease the initial microbial load of the flour and would thereby enhance batter shelf life. In addition, a heat-treated flour is also favorable for enhancing the shelf life since enzymes such as amylase, lipase, peroxidase, and polyphenol oxidase are inactivated. Further, a flour with a low iron content can help to reduce discoloration of the batter during shelf life.

Starch can be added in amounts to completely replace the flour or in amounts to partially replace the flour. A certain percentage of the starch can be modified or pre-gelatinized. The modified starch can improve product strength, structure, and texture. Preferably, the modified starch is added at levels of about 0.1% to about 8.0%. Starches that can be used include the following or combinations of the following in their native or modified form: tapioca starch, corn (maize) starch, arrowroot, wheat starch, potato starch, rice starch, waxy maize starch, barley starch, sago starch, oat starch, waxy sorghum, and the like. The flour and the starch can be blended to obtain desired characteristics in the batter or baked product.

Water activity or aw is the relative availability of water in a substance. It can be defined as the ratio of the vapor pressure of the moisture in a substance to the vapor pressure of pure water. Therefore, pure distilled water has a water activity of exactly one. Water activity is a useful indicator of the availability of water for microbial growth. If the water activity is sufficiently low, microbial growth rates can be significantly reduced. Therefore, the control of water activity is critical in achieving a desired shelf life in an unmodified atmosphere package, and can be adjusted by varying the ratio of moisture to humectants in the batter.

Humectants are added to the formulation to lower the water activity, to sweeten, and to tenderize the baked product. The water activity of the embodiments of the present invention should be 0.92 or less, if the batter is to placed in a package with an unmodified atmosphere and meet a shelf life of greater than 75 days at refrigeration temperatures. In order to lower the water activity to 0.92 or less, humectants are preferably added at levels from about 10% to about 50%. Humectants can be categorized as sugar-based or as non-sugars. The types of sugar-based humectants that can be used include the following or combinations of the following: sucrose, fructose, dextrose, corn syrup, corn syrup solids, invert syrup, high fructose corn syrup, honey, molasses, maltose, sorbose, mannose, lactose, galactose, dextrin, polydextrose, fruit juices, tapioca syrup, rice syrup, concentrated fruit juices, fruit purees, dried fruit powders, high maltose corn syrup, maltodextrin, and the like. The types of non-sugar humectants that can be used include the following or combinations of the following: glycerine, glycerol, sorbitol, mannitol, maltitol, xylitol, propylene glycol, hydrogenated starch hydrolysates, and the like. Combinations of sugar-based and non-sugar humectants can be used in this invention.

Moisture is required in the batter to hydrate the ingredients, improve volume, gelatinize the starch, improve mouthfeel and eating quality of the finished baked product, and disperse ingredients during mixing. The moisture of the batter is determined by summing of the water contained in each ingredient of the formulation. Moisture can be added to the batter as water or added by ingredients containing water, such as liquid whole eggs, margarine, corn syrups, and the like. The amount of moisture depends on the required shelf life. As previously described, shelf life is dependant on the water activity, and can be varied by the level of water and humectant that is added to the batter. Therefore, the level of water and humectants must be balanced to achieve a desired water activity and at the same time meet the desired texture and taste. The batters of this application preferably contain about 10% to about 40% moisture.

Small but effective amounts of anti-microbial agents may be added to preserve the refrigerated batters against yeast, mold and other microbials. Such agents include potassium sorbate, glucono-delta-lactone, sodium propionate, methyl paraben, propyl paraben, calcium propionate, vinegar, alcohol, salts, sodium benzoate, sodium diacetate, sorbic acid, and combinations thereof and the like. The level of preservative that is added depends on the shelf life desired. Natural anti-microbial agents, such as cranberry extract, and the like also can be used. Preferably, preservatives are added at levels from 0% up to about 1%.

To further enhance shelf life, chelating agents can be added to the batters of this application. Chelating agents sequester free metals and thereby reduce the occurrence of color changes and off-flavors in the batter. Chelating agents include Ethylenediaminetetraacetic acid (EDTA), and the like.

Antioxidants such as ascorbic acid, butylated hydroxyl anisole (BHA), butylated hydroxyl toluene (BHT), tertiary butyl hydroquinine (TBHQ), mixtures thereof and the like can be added to the batter to further enhance shelf life by preventing oxidation of the fat and color changes in the batter.

Controlling the pH also improves product shelf life. It is preferable to maintain a pH of less than 7.0 to achieve an extended shelf life. A lower pH aids in preventing microbial growth. Ingredients such as citric acid, sorbic acid, lactic acid, mixtures thereof and the like can be used to lower the pH of the batter. Furthermore, a buffer can be added to regulate the pH of the batter. Such buffers include salts of acetates, lactates, phosphates, citrates, mixtures thereof and the like.

Fats are added to soften, improve volume, and tenderize the finished baked Product, thereby improving the overall eating quality. The fat source can be vegetable, animal, or synthetic. Such fats can include the following or combinations of the following: palm kernel oil, coconut oil, cottonseed oil, butter, peanut oil, sunflower seed oil, sesame seed oil, lard, safflower oil, poppy seed oil, soybean oil, olive oil, corn oil, canola oil, and the like. Although it is recommended that the fat used is a solid, any physical state can be used: liquid, solid, or semisolid. Such forms include plastic shortenings, liquid shortenings, margarines, liquid oil, shortening chips, combinations thereof, and the like. Fats can be hydrous or anhydrous, hydrogenated, non-hydrogenated, partially hydrogenated, fractionated, stabilized with antioxidants or preservatives, flavored, colored, emulsified or combinations of these forms. Preferably, fats are added at a level from about 5% to about 30% by weight.

It is necessary for a portion of the fat to be solid at temperatures of 10° C. and below. This increases the yield stress of the batter at refrigeration temperatures as the product will be sliced directly from the refrigerator. The solid fat can be added directly to the batter or incorporated into margarine or shortening which is then mixed into the batter. It is preferred that a margarine and/or shortening be utilized as it eases mixing of the solid fat into the batter. During mixing, the solid fat portion of the shortening and/or margarine traps air. Once the product is refrigerated, the air cells are locked within the solid fat and thus stabilized. Stabilization of air cells is an important factor in achieving a shelf life greater than 75 days. When the batter is baked, the air cells within the solid fat expand. This initial expansion results in a finished product with a high backed specific volume. A batter with not enough solid fat at refrigerated temperatures will lose air during storage, will have a low baked specific volume, and will not meet the desired shelf life. In a preferred embodiment of the present invention, a shelf life greater than 112 days is achieved.

Thus, the solid fat serves three main functions: i) in maintaining a hardness at 10° C. and below, ii) incorporating air during mixing, and iii) stabilizing air cells during refrigerated storage. In addition to these three functions, the fat needs to tenderize the finished baked product to improve eating quality. Therefore, it is recommended that the fat be soft at room temperature.

Solid Fat Content (SFC) is the percentage of the total fat that is solid at a specific temperature. It is preferred that the batter of the invention utilizes a fat with the following solid fat profile in order to achieve all of the above requirements.

TABLE 1

| TEMP (° C.) | SFC Range (%) |
|---|---|
| 10 | Preferably from 35%-70% |
| 20 | Preferably from 12%-42% |
| 25 | Preferably from 4%-31% |
| 30 | Preferably from 1%-24% |
| 35 | Preferably from 1%-20% |
| 40 | Preferably from 1%-15% |

The level of solid fat and gelatin are interdependent and can be varied to achieve a batter with a desired yield stress. For example, a batter containing gelatin at its low end of the range will need a fat with an SFC in its upper end of the range in Table 1. Thus, the used percentages of solid fat and gelatin in their corresponding ranges are generally inversely proportional. Alternatively, the total fat could be increased to a higher percentage within the range of total fat so that there is enough solid fat in the batter to achieve the desired yield stress.

The leavening system used in the embodiments of the present invention consists of an acid and base, which react to produce carbon dioxide. The evolution of carbon dioxide during the baking process imparts volume and lightness to the finished product. The leavening base and source of carbon dioxide is sodium bicarbonate. The types of leavening acids that can be used consist of the following or combinations of the following: monocalcium phosphate, dimagnesium phosphate, potassium acid tartate, monocalcium phosphate anhydrous, sodium acid pyrophosphate, sodium aluminum pyrophosphate, dicalcium phosphate, sodium aluminum sulfate, glucono delta lactone, potassium hydrogen tartate, sodium aluminum phosphate, and the like. It is important that the acid and base do not react during storage of the batter. One method of preventing the leavening reaction is to encapsulate either the acid or the base. This coating prevents the interaction of the acid with the base until the batter is placed in the oven, which causes the coating to melt and allows the leavening reaction to take place.

Another method for preventing the leavening reaction during storage is through the use of a heat activated leavening system. In this case, the reaction between the acid and base does not take place until a specific temperature is reached. Such heat activated leavening acids that can be used include the following: dicalcium phosphate dihydrate, glucono-delta-lactone, alpha-glucoheptone-gamma-lactone, sodium aluminum phosphate, sodium acid pyrophosphate, and the like. The preferred leavening system of the embodiments of the present invention consists of a heat activated acid, and sodium bicarbonate. Preferably, the leavening system is added at a level from 0% up to about 3%. The batter can be made to rise without leavening, if air is whipped into the batter during mixing.

Emulsifiers are added to the batter to improve volume, texture, eating quality, and to help stabilize the batter during refrigerated storage. The types of emulsifiers that can be used consist of the following or combinations of the following: propylene glycol esters of fatty acids, mono- and diglycerides, succinyl monoglyceride, acetylated monoglycende, ethoxylated monoglycerides and diglycerides, diacetyl-tartrate ester of monoglycende, sucrose esters, propylene glycol monoester, lactylated monoglycerides, citric acid esters of monoglyceride, sorbitan monostearate, polysorbate 60, polysorbate 65, polysorbate 80, sodium stearoyl lactylate, lecithin, sodium stearoyl fumarate, propylene glycol monoester, and the like. Preferably, emulsifiers are added at a level from about 0.1% to about 5%.

Texturizing agents such as whole egg, egg whites, egg yolk, egg replacers, nonfat dry milk, dried buttermilk, dried whey, milk protein concentrate, soy protein, gluten, casein, whey protein concentrate, and the like can be added to the batter to improve mouthfeel, flavor, and texture. Whole eggs are the preferred texturizing agent. Texturing agents preferably are added at levels from 0% up to about 15%.

Ingredients that can enhance the nutritional value of the baked product can be added to the batter and include the following or combinations of the following: fiber, vitamins, proteins, minerals, fortified flour, fat replacers, soy, prebiotics, nutraceuticals, and the like.

Inclusions can be added to the batter and include the following or combinations of the following: nuts, chocolate, shortening flakes, oats, flavored bits, caramel, fruits, butterscotch, and the like. If using a flavored bit, the bit can be fat-based to minimize dissolution during storage. Generally, inclusions, if they are included in the formulation, are added at a level from about 2% to about 25%.

Other ingredients, known to those skilled in the art, can be added to the batter to help improve color, flavor, or quality. Such ingredients include flavors, colors, molasses, salt, sweeteners, high intensity sweeteners, cocoa, cornmeal, corn flour, spices, and the like.

Table 2 shows a summary of the major components contained in the preferred embodiment of the present invention. Percentages are weight percentages and are based on the total weight of the batter.

TABLE 2
Summary of the major components contained in the batter
of the preferred embodiment of this application.

| Major Component | Percentage |
|---|---|
| Flour and/or starch | 10-60.0% |
| Pre-gelatinized starch and/or modified | 0-8.0% |
| starch | |
| Hydrocolloids | 0.1-5.0% |
| Fats | 5.0-30.0% |
| Humectants | 10.0-50.0% |
| Anti-microbial agents | 0-1.0% |
| Leavening system | 0-3.0% |
| Texturizing agents | 0-15.0% |
| Moisture | 10.0-40.0% |

The batter of this application has yield stress values that range from about 3000 Pa to about 6000 Pa. At these high yield stress values, the batter is able to retain its shape. Therefore, the batter can be stored in forms that permit easy portioning. As previously mentioned, one example of a convenient form is individual portions like round or hex pucks. Another example is a log format where the portions can be sliced from the log. The log format is typically packaged in “chubs” (see FIG. 3), which are commonly used for cookie dough. Since the batter is stored in an unmodified atmosphere in these forms, the consumer can open the package and place the remaining batter back into the refrigerator to be used at a later date. Whatever the form, the end user would place the portion or portions onto a suitable baking pan and bake the product for a pre-determined amount of time.

In addition to storage at refrigerated temperatures, the batter of this embodiment of the present invention can also be frozen (stored at temperatures less than 0° F.). Storage at frozen temperatures can extend the shelf life of the product. Also, if stored as individual units in the freezer, the frozen portions can be placed directly in the oven without thawing the batter prior to baking. Generally, if frozen, the batter would need to be baked at a lower temperature for a longer time.

Depending on the shelf life and storage requirements, different types of packaging materials can be used. Materials with barriers to light, moisture, oxygen, and other gases, combinations thereof, and the like can be used. If the batter is to be stored at refrigerated temperatures in a chub, it is recommended that the film has good moisture and oxygen barriers. The batter can also be placed into a package with minimal barrier properties if it is stored frozen or requires a minimal shelf life at refrigerated temperatures. For added convenience, the batter can be placed in bakable packaging where the consumer simply places the entire unit (the batter and packaging) directly into the oven.

Although the product of this application has been described in detail as a batter stored under unmodified atmospheric conditions, the batter also can be stored in a modified atmosphere package (MAP). A MAP package can be described as a package where the air in the headspace surrounding the product within a package has been modified. This can be accomplished when air, which contains oxygen, is flushed from the package with inert gases, usually carbon dioxide, nitrogen, or a combination thereof. The atmosphere can also be modified by the chemical leavening contained in the batter. In this case, the chemical leavening in the batter reacts to produce carbon dioxide, which modifies the atmosphere within the package. Oxygen scavengers also can be placed in the package to modify the atmosphere in the headspace surrounding the batter. The modified atmosphere aids in the prevention of microbial growth; therefore, the water activity of the batter can be increased and still achieve a shelf life of greater than 75 days.

The following example of a muffin batter stored in a chub at refrigerated temperatures depicts a non-limiting illustration of the various attributes of an embodiment of the present invention. All percentages are weight percentages and are based on the total weight of the batter.

In order to prepare the batter in Table 4, the gelatin premix in Table 3 is first made. The premix is made in a kettle where the amount of water required for the premix is heated from 80 to 90° C. While the water is stirred vigorously, powdered gelatin is added slowly. The gelatin is mixed for 2 minutes at this temperature. The heat is then turned off and the solution is let to cool to 50-60° C. The premix is maintained at this temperature until it is ready to be added to the mixing bowl.

A Hobart mixer may be used to mix the batter. All the dry ingredients (sugar, flour, dried egg, cornstarch, gluten, nonfat dry milk, SSL, xanthan gum, salt, baking soda, sodium aluminum phosphate SALP) are placed in the mixing bowl and mixed on low speed until evenly dispersed. The fats (margarine and shortening) are then added and mixed for 3 minutes. The liquid ingredients (glycerine, high fructose corn syrup, water, lecithin, and polysorbate 60) are subsequently added to the mixing bowl and mixed for 1 minute. The gelatin premix is then added and mixed for 1 minute. After mixing is completed, the batter is placed in a tube of plastic film. The ends of the tube are clipped to provide an airtight seal and create a chub. The chubs are then placed in a refrigerator. Maximum batter stiffness is achieved after 15-18 hours storage at refrigeration temperatures.

TABLE 3
Gelatin Pre-Mix

| Ingredient | Percentage (%) |
|---|---|
| Sugar | 16.67 |
| Gelatin | 10.87 |
| Water | 72.46 |

TABLE 4
Muffin Batter of Present Invention

| Ingredient | Percentage (%) |
|---|---|
| Sugar | 23.40 |
| Cake Flour | 25.00 |
| Dried Whole Egg | 3.00 |
| Margarine | 10.00 |
| Shortening | 8.10 |
| Modified Pre-gelatinized Corn Starch | 1.50 |
| Gluten | 0.50 |
| Non Fat Dry Milk | 0.86 |
| Sodium Stearoyl Lactylate (SSL) | 0.20 |
| Glycerine | 2.00 |
| Xanthan Gum | 0.03 |
| High Fructose Corn Syrup | 3.50 |
| Salt | 0.44 |
| Baking Soda | 0.44 |
| Sodium Aluminum Phosphate (SALP) | 0.44 |
| Potassium Sorbate | 0.55 |
| Lecithin | 0.30 |
| Vanilla Flavor | 0.20 |
| Polysorbate 60 | 0.44 |
| Water | 12.1 |
| Gelatin Pre-Mix | 7.00 |

The water activity of the forgoing formulation of Table 4 was measured at 0.80. The microbial load was monitored during its shelf life. After 75 days of storage at refrigerated temperatures, the batter was still acceptable. Table 5 shows the lab test results.

TABLE 5
Microbial Test Results at 75 days Refrigerated Storage

| | Level Found | Standard |
|---|---|---|
| Analysis | (cfu/g) | Microbiological Test |
| Aerobic Plate Count | 2,900 | FDA III |
| Anaerobic Plate Count | 8,800 | MEF4 |
| Mold | <10 | FDA XVIII |
| Yeast | <10 | FDA XVIII |

A comparison study was run to demonstrate the stiffness of the batter of an embodiment of the present invention once maximum gel strength is achieved. The batter in Table 4 above was compared to the batter formula provided in Table 3 of Hahn. This formulation provided by Hahn was duplicated; ingredients that were not specified in detail were accommodated with the most suitable ingredient that followed Hahn patent guidelines. Table 6 shows the formulation prepared according to Hahn that was prepared for testing.

TABLE 6
Hahn, Spoonable Batter Stored at Refrigerated Temperatures
(From Table 4 of U.S. Pat. No. 6,217,929)

| Ingredient | Percentage (%) |
|---|---|
| Water | 17.47 |
| Egg Solids | 3.47 |
| Sugar | 21.97 |
| High Fructose Corn Syrup | 10.45 |
| Emulsifiers - sodium stearoyi lactylate | 0.2 |
| Emulsifiers - plastic monoglycerides | 0.6 |
| Emulsifiers - lecithin | 0.3 |
| Baking powder | 0.52 |
| Soybean Oil | 13.22 |
| Flavor - vanilla | 0.33 |
| Salt | 0.40 |
| Milk Solids | 0.99 |
| Flour-all purpose | 27.49 |
| Potassium sorbate | 0.17 |
| Citric Acid | 0.11 |
| Starch - regular cornstarch | 1.5 |
| Gluten | 0.49 |
| Gums - xanthan | 0.1 |
| Calcium Acetate | 0.08 |

The yield stress values were determined by using the Haake model VT 550 viscotester. Refrigeration temperature was maintained during testing with a set-up using a styrofoam cooler (interior dimensions of 10×12 inches) and freezer packs. A sample container was placed in the cooler and the surrounding space was filled with freezer packs turned on edge to give maximum depth. This prevented the container from moving after approximately 200 mL water and some crushed ice were added down the side away from the sample. The cooler could then be placed on a jackstand and raised to the appropriate vane insertion level for testing. Samples were tested while temperature remained in the 4.1-4.8° C. range. If the sample cooled outside this range in the cooler, it was taken out and allowed to warm for 2 to 5 minute intervals on the counter before equilibrating again in the cooler set-up. Samples were tested in triplicate using a 4 bladed vane that was 14 mm in diameter. The testing procedure involved zeroing the viscotester and inserting the vane to a depth of 10 mm. Samples were run at a shear rate of 0.2/sec. Values of M, torque, were taken twice each second during testing and were graphically displayed during the test. After a sample reached maximum torque and clearly began to shear, the test was manually stopped and an ending sample temperature was taken. Maximum value for M was taken from the chart and the yield stress was calculated by Equation (1).

$${σ}_{0} = \frac{2 {M}_{0}}{π {d}^{3}} {( \frac{h}{d} + \frac{1}{6} )}^{- 1} \qquad ( 1 )$$

### Where:

δ—is a symbol and stands for yield stress,

M—is the torque reading on the viscometer,

d—is the diameter of the vane (tool) that is used on the viscometer, and

h—is the depth that the vane is inserted into the batter.

The average yield stress of the formulation in Table 4 above was 3,443 Pa with a standard error of 59 Pa. The average yield stress of Hahn was 444 Pa with a standard error of 14 Pa.

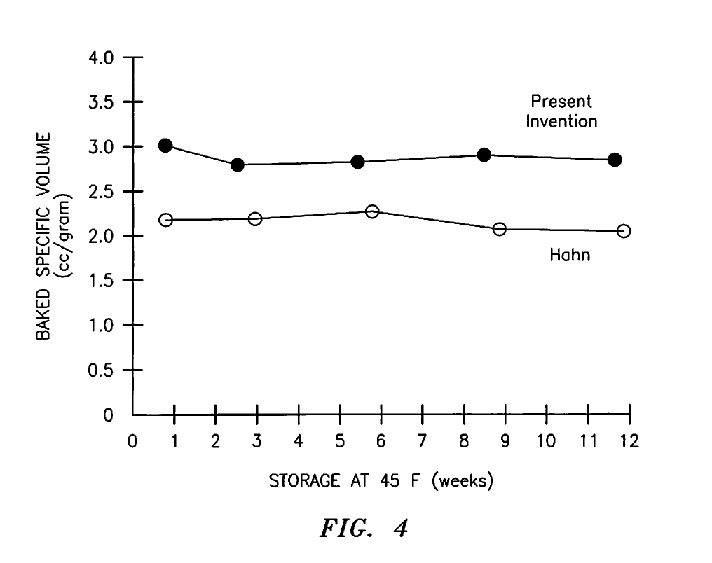

Although the batter of the present application has a significantly higher yield stress than both conventional batters and Hahn, the batter still bakes into a bakery product that has a specific volume typical of bakery products made from conventional batters. FIG. 4 compares the baked specific volume of the present application to the baked specific volumes of the spoonable batters shown in FIG. 3 of Hahn. The batter of the present invention has a baked specific volume of 2.5 cc/g and maintains this baked specific volume even after 75 days of storage. On the other hand, Hahn starts out with a baked specific volume of 2.5 cc/g and after 75 days of storage, the baked specific volume decreases to approximately 1.8 cc/g.

As an example of another product that can be made from an embodiment of the present invention, Table 7 is an example of a brownie formulation. All percentages are weight percentages and are based on the total weight of the batter.

TABLE 7
Brownie Batter of Present Application

| Ingredient | Percentage (%) |
|---|---|
| Sugar | 36.92 |
| Flour | 15.35 |
| Cocoa | 3.11 |
| Non Fat Dry Milk | 1.22 |
| Salt | 0.44 |
| DiCalcium Phosphate | 0.11 |
| Gellan Gum | 0.10 |
| Sodium Bicarbonate | 0.03 |
| Shortening | 13.35 |
| Whole Eggs | 12.23 |
| Gelatin Pre-Mix (see below) | 7.78 |
| Flavor | 0.33 |
| Water | 4.23 |
| Starch | 1.67 |
| Chocolate Liquor | 3.11 |
| Gelatin Pre-Mix | |
| Sugar | 17.56 |
| Gelatin | 6.11 |
| Water | 76.33 |

The various ingredients listed in Table 7 above were mixed. The brownie dough was pumped into a chub. The chub was then stored for more than 75 days at refrigerated temperatures. The chub was then sliced to yield 2″ diameter×9 portions (each portion weighing approximately 2 oz). The pieces were then placed in an 8″×8″ baking pan, equal distances apart and baked in an oven for 25 minutes at 350° F. The viscosity of the brownie decreases in the oven, which permits the brownie portions to flow and bake into an individual brownie sheet. The brownie portions can also be baked in a muffin cup and/or muffin pan or placed directly onto a baking sheet.

Blaschke makes reference to a brownie dough. However, the brownie dough of this embodiment of the present invention is of higher quality because gelatin is used to stiffen the batter whereas Blaschke requires a higher level of solids such as flour (30% flour based on total weight of batter) in their formulation to achieve a stiff brownie dough. The higher level of flour results in a thicker crust and a “cakey” texture. The flour level of a typical brownie ranges form about 13% to about 19%. And, this low flour level can be maintained with the use of gelatin to produce a stiff brownie batter (yield stress>3000 Pa). As a result, the brownie dough of the present application more closely resembles a typical brownie in texture and appearance.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A stiff batter comprising:
a range of about 0.5% to about 2% gelatin;
a range of about 10% to about 60% farinaceous ingredient; and
a range of about 5% to about 30% fat, wherein the fat has about 35% to about 70% solid fat content at approximately 10° C., and used percentages of solid fat content and gelatin in their corresponding ranges are inversely proportional;
wherein the stiff batter has a pre-baked yield stress greater than 3000 Pascals (Pa) at approximately 4.5° C., a baked specific volume of at least 2.0 cubic centimeters/gram (cc/gm), and maintains the baked specific volume at approximately 4.5° C. for more than 75 days;
wherein all percentages, with the exception of the solid fat content, are based on a weight of the stiff batter; and
wherein the stiff batter does not require gluten development to achieve the baked specific volume of at least 2.0 cc/gm.

2. The stiff batter of claim 1, wherein the stiff batter is selected from a group consisting of a muffin batter, a cake batter, a cupcake batter, a drop biscuit batter, a scone batter, a pancake batter, a cinnamon bun batter, a donut batter, a waffle batter, and a brownie batter.

3. The stiff batter of claim 1, wherein the stiff batter is stored as at least one of a shaped log that can be sliced into individual pieces, in pails, in bakable packaging, as individual pieces of any shape, as scored or unscored rectangular blocks that can be cut or broken into individual pieces, and as a flat sheet.

4. The stiff batter of claim 1, wherein a flour of the farinaceous ingredient comprises at least one of hard wheat flour, soft wheat flower, chlorinated wheat flour, corn flour, soy flour, rice flour, high amylose flour, and low amylose flour.

5. The stiff batter of claim 4, wherein the flour is wheat flour.

6. The stiff batter of claim 5, wherein the wheat flour is a chlorinated wheat flour.

7. The stiff batter of claim 4, wherein the flour is heat-treated to inactivate enzymes and decrease microbial load.

8. The stiff batter of claim 1, wherein a starch of the farinaceous ingredient comprises at least one of tapioca starch, corn (maize) starch, arrowroot, wheat starch, potato starch, rice starch, waxy maize starch, barley starch, sago starch, oat starch, and waxy sorghum.

9. The stiff batter of claim 8, wherein the starch comprises modified starch in the amount of 0% to about 8% by weight.

10. The stiff batter of claim 1, wherein the stiff batter has a water activity less than or equal to 0.92 and is stored in an unmodified atmosphere package.

11. The stiff batter of claim 1, wherein the stiff batter is stored in a modified atmosphere package.

12. The stiff batter of claim 10, further comprising about 10% to about 50% humectants and about 10% to about 40% moisture.

13. The stiff batter of claim 12, wherein the humectants comprise at least one of sucrose, fructose, dextrose, corn syrup, corn syrup solids, invert syrup, high fructose corn syrup, honey, molasses, maltose, sorbose, mannose, lactose, galactose, dextrin, polydextrose, fruit juices, tapioca syrup, rice syrup, concentrated fruit juice, fruit purees, dried fruit powders, high maltose corn syrup, maltodextrin, glycerine, glycerol, sorbitol, mannitol, maltitol, xylitol, propylene glycol, and hydrogenated starch hydrolysates.

14. The stiff batter of claim 1, further comprising up to about 1% anti-microbial agent.

15. The stiff batter of claim 1, further comprising up to about 3% leavening ingredients.

16. The stiff batter of claim 15, wherein the leavening ingredients comprise a heat activated acid and sodium bicarbonate.

17. A stiff batter comprising:
a) a range from about 10% to about 60% farinaceous ingredient;
b) a range from about 0.5% to about 2% gelatin;
c) a range from about 5% to about 30% fat, wherein the fat has about 35% to about 70% solid fat content at approximately 10° C., and used percentages of solid fat content and gelatin in their corresponding ranges are inversely proportional;
d) a range from about 10% to about 50% humectant;
e) a range from about 10% to about 40% moisture;
f) a range from 0 to about 1% anti-microbial agent;
g) a range from 0 to about 5% emulsifier;
h) a range from 0 to 3% leavening system; and
i) a range from 0 to about 15% texturizing agent;
wherein the stiff batter has a pre-baked yield stress greater than 3000 Pascals (Pa) at approximately 4.5° C., a baked specific volume of at least 2.0 cubic centimeters/gram (cc/gm), and maintains the baked specific volume at approximately 4.5° C. for more than 75 days;
wherein all percentages, with the exception of the solid fat content, are based on a weight of the stiff batter; and
wherein the stiff batter does not require gluten development to achieve the baked specific volume of at least 2.0 cc/gm.
